(19) United States
(12) Patent Application Publication
(10) Pub. No.: US 2024/0164495 A1
(43) Pub. Date: May 23, 2024

(54) CONTAINER, ESPECIALLY SUITCASE, COMPRISING AT LEAST ONE HALF-SHELL COMPONENT OR SHELL

(71) Applicant: Kogelnik Holding GmbH, Hof bei Salzburg (AT)

(72) Inventor: Michael KOGELNIK, Hof bei Salzburg (AT)

(73) Assignee: Kogelnik Holding GmbH, Hof bei Salzburg (AT)

(21) Appl. No.: 18/283,033

(22) PCT Filed: Mar. 11, 2022
(86) PCT No.: PCT/AT2022/060070

§ 371 Date: Sep. 20, 2023

(30) Foreign Application Priority Data
Mar. 24, 2021 (AT) A60092/2021

(51) Int. Cl. A45C 5/02; A45C 5/03; A45C 5/14; A45C 13/26; B29C 44/12; B29C 44/34; B29C 44/42; B29C 44/58; B29C 45/00; B29C 45/14; B29C 45/37; B29K 105/04; B29K 105/06; B29L 31/00

(52) U.S. Cl. CPC A45C 5/02; A45C 5/03; A45C 5/14; A45C 13/262; B29C 44/1271; B29C 44/3446; B29C 44/42; B29C 44/586; B29C 45/0013; B29C 45/14336; B29C 45/376; A45C 2005/037; A45C 2005/148; B29K 2105/04; B29K 2105/06; B29K 2995/0094; B29L 2031/7418

(57) ABSTRACT

An injection-molded container or shell, in particular a suitcase shell made of plastic, A) is made of foamed plastic and has gas channels and/or B) is made using physically or chemically foamed plastic and/or a plastic mixed with hollow fillers and/or C) is integrally made with wheel mounting axles and/or extendable rod buffers and/or extendable rod cavities.

The invention pertains to a container, particularly a suitcase, with at least one semi-shell-shaped component or shell.

The invention also pertains to a method for the production of an injection-molded shell or container shell, particularly a suitcase shell.

Mostly rigid plastic shells or plastic casings, which require large external dimensions relative to the wall thickness, are today almost exclusively produced using thermoforming (deep drawing). This method is frequently used especially for various containers such as roof boxes for automobiles, transport containers, hard-shell backpacks, suitcases, travel bags, transport boxes, shipping boxes, containers, plastic boxes, toolboxes, boxes, and so on.

This method is also suitable for various casing elements of devices, machines, vehicles, and so on.

In the following, the production of suitcases will be focused on, however, it is advantageous and conceivable to also apply the invention to other objects and containers with similar requirements—such as bags, hard-shell backpacks, transport boxes, logistics containers, and so on.

The advantages of the thermoforming process lie in the low tooling costs, and in that a very good ratio of wall thickness to dimensions can be achieved. For instance, it allows the manufacture of suitcase shells with dimensions of 50×40×15 cm or even more, which have a wall thickness of only 1.5-2.5 mm.

However, below this wall thickness, it becomes difficult to produce a component of these dimensions with sufficient strength using the deep-drawing method.

The low tooling costs are, however, offset by relatively high per-piece costs in series production. The typical unit costs of a thermoformed component are five to ten times the cost of a comparable injection-molded component. Reasons for these significantly increased costs lie in the complex process of thermoforming and in the cycle times. In addition, several further processing steps are needed until the thermoformed component becomes a finished product. For suitcases, for example, a plastic plate is first produced from plastic granules by extrusion. This plate is then transformed into a shell by deep-drawing, for which several steps in the machine (heating, vacuum forming into a shape, removal from the mold, further transport out of the thermoforming machine, etc.) are necessary, which are well known and therefore do not need to be explained in detail. After the actual deep-drawing, however, the transformed plate is trimmed or punched at its edges using a CNC machine. This results in some waste that is not really reusable. In sum, deep-drawing is a slow, complex, and therefore more expensive process.

A)

The edge of the shell in deep-drawn shells is typically relatively fragile, flexible, and less rigid, often also not really precise in its position.

U.S. Pat. No. 5,894,007 describes a thermoforming method, where conventional thermoforming of suitcase shells is essentially supplemented by sliders that invert the shell inward and thus form a reinforcing frame. Hinges and the like are then attached to this frame. A disadvantage of the method is that the frame stands inward, making access to the clothes in the suitcase more difficult. This frame undoubtedly represents an improvement in the rigidity of the shell, but it is questionable whether this relatively small reinforcement is sufficient to replace a classic frame made of, for example, aluminum, and to ensure a firm closure of the suitcase. Another disadvantage is that the two suitcase shells do not really meet from the outside when folded together, creating a gap in the image of the suitcase. All attachments such as wheels, pull rods, and so on are then attached to the shell in subsequent steps.

A peculiarity of deep-drawing is also that the wall thickness is relatively small, but not the same everywhere. Especially at the container corners or suitcase corners, where complex deformations are required, the wall thickness is often significantly thinner than in straight areas. To ensure the required minimum strength at all points, the container shell or suitcase shell must be oversized in thickness in the straight areas. This increases the total weight of the component. US20160338463A1 proposes special reinforcement elements to solve this problem, which should be attached to the inside of the suitcase corners to further stiffen them.

As an alternative to the deep-drawing process, shells and containers, especially suitcase shells, are produced using the injection molding process. Injection molding can significantly reduce unit costs, as the cycle times are shorter, plastic granules are sufficient as starting material, and further processing steps such as CNC trimming and the like are usually omitted.

An important advantage of injection molding over deep-drawing is also that the surface can be very precisely defined, for example, with high-gloss spots on an otherwise matte, rough surface. This is not achievable with the same precision in deep-drawing, because the pressure on the mold is much lower and therefore small details cannot be reproduced.

However, injection molding has the disadvantage that the maximum ratio of wall thickness to dimension of the component (flow length of the plastic) is not arbitrarily high, and is generally much lower than with deep-drawing. In practice, therefore, suitcase shells manufactured by injection molding are significantly heavier than deep-drawn suitcase shells. This represents a significant disadvantage in the market and so far has not led to a wider spread of this manufacturing method.

EP2387906B1 describes a suitcase shell provided with a network of thicker channels, which are intended to improve the flow of the material in the injection mold. Without these channels, it would be impossible to manufacture a suitcase with a wall thickness of less than 2 mm using the injection molding process, making suitcases manufactured in this way relatively heavy. Through the channels, the thinner areas can be made thinner than normal, making the suitcase overall somewhat lighter. According to the drawings, the suitcase shells may have integrated hinges and areas for wheels, although it is not clear how the wheel mount should be specifically executed, leading to the assumption that this should happen in the conventional sense through attachments. Inside the suitcase, a conventional pull handle is to be attached.

The thicker channels might improve the flowability of the plastic, but they are quite unsightly and relatively heavy, as their dimensions extend over large areas of the shell. Due to the large jump from the thick flow channel to the thin wall, it must be expected that there will be deformations of the shell and unsightly sink marks during cooling after the injection molding process. The flow channels are technically determined and therefore largely define the shape of the suitcase, allowing only a very limited choice of design options.

ITMI20101347A1 describes suitcase shells made of polycarbonate, which are manufactured using the conventional injection molding process, with particular care being taken to ensure that the wall thickness remains constant in all zones and that the shell is made via multiple injection points. This is intended to improve the flow of material in the mold. The shells are stiffened by a separately manufactured frame 15, which is connected to the shells by various connection methods.

U.S. Pat. No. 6,367,603 describes a suitcase made of two identical shells, which are manufactured using the injection molding process. Since the shells are identical, tooling costs are reduced. However, this results in several other disadvantages. For example, holes that serve on the back of the suitcase for the telescopic handles must be stuffed on the front with parts 376a. The shells have integrated hinge devices, which still have to be secured with a pin during assembly, and integrated side handles. The hinge devices 104 are attached on both sides of the suitcase, but if the shells 25 are actually supposed to be identical, it is not clear how the hinge devices are attached without getting in each other's way. In a possible embodiment, areas for wheels are also integrated. It is not clear how these receptacle areas should be formed and could be molded to provide the necessary functionality in an injection molding process. The locking mechanism cannot hold the telescopic rods in the position of use. No special devices are mentioned that serve to make the plastic flow better in the mold, so it can be assumed that the wall thickness and thus the weight will be relatively high in practice.

Injection molding allows considerably more freedom in component design compared to thermoforming. In particular, with injection molding, the open edge of the suitcase shell could be stiffened by ribs and the like.

CN104287380B shows a suitcase construction made of many different components, including various frame elements and other intermediate parts.

DE202004011972U1 shows a suitcase or container with a particularly complex frame construction. It involves a plastic suitcase reinforced with an aluminum profile, which in turn is form-fit connected with another plastic profile.

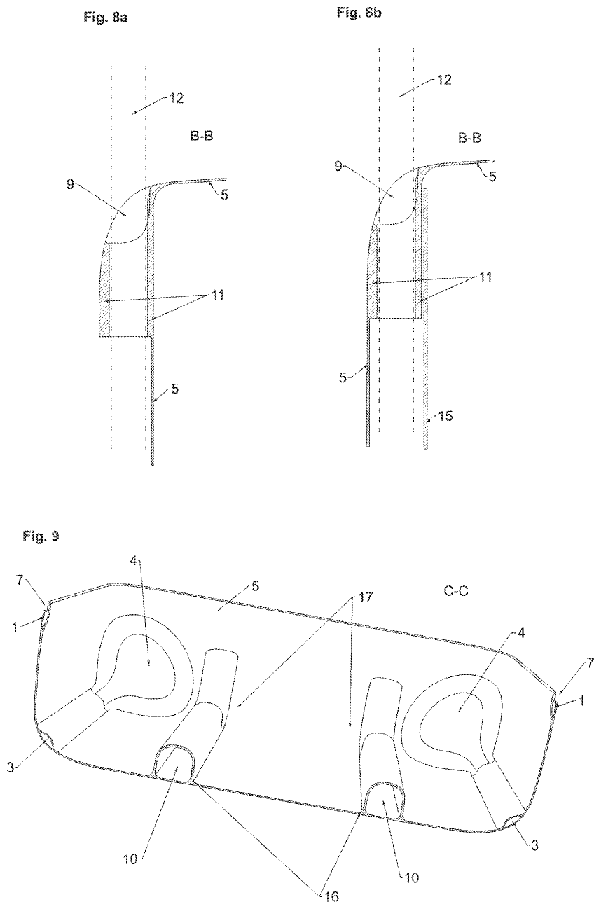

DE000069530362T2 describes a suitcase made of cast plastic. The suitcase shells have overlapping, to a certain extent stiffening frame constructions at their edges (see FIG. 8). The suitcase is also equipped with various handles and wheels, which serve to pull the suitcase.

Such frame stiffenings are certainly suitable for stiffening the suitcase shell, but they are also relatively unattractive to look at. Viewed from the outside, the suitcase thereby receives striking circumferential lips or bulges. When open, the overlapping area stiffened with ribs is openly visible.

DE000069015377T2 describes a suitcase with a central frame, which is somewhat stiffened by U-shaped shaping at its edges. In addition, it is envisaged that the central frame is stiffened by another component to form a hollow girder. This hollow girder thus consists of two separate components that are assembled and which together form a closed O-profile.

DE000020217410U1 describes a suitcase with a double-walled structure, which is intended to increase its rigidity. This double-walled structure is elaborately manufactured via several pairs of panels (three pairs of edge panels, four pairs of corner fittings, and two side panels), which are to be connected to each other.

CN209644174U describes a suitcase shell made by injection molding, whose sides are reinforced by a stepped design, combined with internal ribs. A graphic is also shown that illustrates that the separately manufactured wheel housings can be attached to this shell via screw holes provided for this purpose.

DE000001757114C3 shows suitcase shells with a frame construction, which has metallic reinforcing elements and is additionally stiffened with a suitable shaping of the plastic itself and is suitable for receiving the metallic reinforcing elements.

CN101375751A describes a suitcase or other container, the shell of which consists of three parts: a central plate, which is formed by extruding a profile, and two side parts, which are formed by injection molding. The central plate has an extrusion profile with cavities, making it lightweight but simultaneously stiff.

In order to achieve sufficient strength despite a low wall thickness, especially in straight areas and suitcase corners, suitcases are typically stiffened by various grooves, waves, and the like. These grooves naturally help to increase the moment of inertia somewhat. US20160113366A1 shows a typical and practically applied possibility of stiffening a shell made by thermoforming by means of grooves, waves, and the like.

These grooves significantly influence and shape the appearance of the suitcase. Today, almost all suitcases have some grooves or other forms, and it would indeed be an attractive unique selling point to establish a suitcase on the market that does without these grooves or other externally visible stiffening devices yet is still sufficiently rigid.

In summary, it can be stated that suitcase shells or comparable shells and containers are almost exclusively produced by deep-drawing process today, with various frame constructions or other stiffening elements that are retrofitted to the deep-drawn shell to compensate for the weak points of deep-drawing.

Conversely, a shell could be produced much more cost-effectively using the injection molding process, and various stiffening ribs and the like have been developed, which could be produced integrated with the shell in the injection molding process. This integration would significantly reduce manufacturing costs. However, in injection molding, the wall thickness of the suitcase must, for plastic-flow reasons, be significantly higher than in thermoforming. Various solutions have also been developed for this problem, all of which have various disadvantages in terms of strength, deformation, weight, and appearance.

Thus, the task according to the invention is to develop a shell that can be produced extremely cost-effectively using injection molding, but is lighter or at least as light as a deep-drawn shell, and which has stiffening elements, in particular stiffening of the frame and the surface of the shell, which elements should be as little visible or tangible from the outside as possible, or even when opening the suitcase, thus offering the greatest possible freedom for the design of the shell.

The problem is solved by a shell according to claim 1. Preferred embodiments are specified in the dependent claims.

“Integrated,” “integratively manufactured,” or “integral” in this context is understood to mean that the element integrated or integratively or integrally manufactured with the shell is produced and/or encapsulated with the shell during the injection molding process. The integrative manufacturing allows the element and the shell to be irretrievably connected to each other and/or executed as one piece. Thus, in this context, “integrated,” “integratively manufactured,” or “integral” also means that the element is irretrievably connected to and/or executed as one piece with the shell.

In a possible embodiment, a shell or suitcase shell according to the invention, which is produced using the TSG process combined with variotherm, is also combined with a gas injection process.

According to the invention, a shell may be provided which has gas channels at suitable locations, which gas channels are integratively manufactured with the shell in the injection molding process with gas injection, and which gas channels are used in combination with foamed plastic. The gas channels are strategically placed so that they serve both to stiffen the shell at suitable locations and at the same time as a flow aid for the plastic in the mold.

In injection molding, the gas injection process is known. In this process, an inert gas, usually nitrogen, is introduced into the plastic and forms a cavity there.

KR20150001254A, for example, describes a beverage box with handles that are hollow inside.

CN1891430A describes a glove compartment of a car, where the edges of the glove compartment have a thicker wall thickness. To avoid shrinkage at the thicker edges, a cavity is formed at the edges by gas injection, with the cavity to wall thickness ratio being about 1:1, more precisely between 1.2:1 and 1.1:1. The open edges of the glove compartment and also the largely flat surfaces remain strengthened. The gas channels are therefore only used to reduce the shrinkage of the thick areas and are thus not suitable for supporting the flow of the plastic in the flat areas or for increasing the stiffness of the flat areas or for stiffening the open edges.

CN203467878U does not describe a suitcase, but only a suitcase frame. This is to be made not from aluminum, but from plastic. Gas channels are to be formed in the frame. It is not clear how these gas-filled channels should be produced, especially since they are supposed to be circumferential. Due to the channel shape, the frame is supposed to be stiffer than an aluminum frame. The suitcase frame is then connected to the suitcase shell, although it is not described how this shell could be shaped and connected to the frame, however, the frame shows shapes similar to clip mechanisms. The cuts of the suitcase frame show three channels with a round cross-section, which are very closely spaced. This seems hardly feasible in practice with gas injection technology: due to the specific behavior of the gas in the molten plastic, a very unstable process would be expected. It is also evident that the wall thickness to gas channel diameter ratio is relatively large, i.e., about 1:1. Therefore, the gas channel theoretically reduces the weight, but the remaining wall thickness is still relatively high. If the gas channel, for example, had a diameter of 3 mm, the wall of the plastic would also have to be 3 mm thick—the weight of such a frame would therefore be considerable. The plastic frame must in any case be connected to the shell in an extra work step, which means significantly increased manufacturing costs.

FR2605197 A1 discloses a travel item, such as a suitcase or bag, characterized in that the injection-molded part has at least one closed tube rib for reinforcement, which is obtained by a known method of gas blowing during injection molding (see especially FIG. 5-8).

JPH0511828U, JPH0520624U, and JPH0511816U each show a piece of luggage with a reinforcing frame in which a cavity is formed during the manufacturing process (injection molding) by injecting gas into the plastic melt/resin (see, for example, D2 [0013] The graphics here also show a wall thickness:gas cavity ratio of about 1:1.

GB2158002 A describes the injection molding of a component (a shell/box) with at least one area of increased thickness, with the thicker section containing an inner cavity that results from the transmission of an internal pressure through the thicker section onto the plastic during the molding process.

CN207949207U describes a frame for suitcase shells, which has a hollow area produced by inert gas. The frame is attached to the (deep-drawn) shells. The graphics here also show a wall thickness:gas cavity ratio of about 1:1.

JP2016028890 A also shows such a subsequently fixed frame with wall thicknesses:gas cavity ratio of about 1:1.

The prevailing wall thickness:gas cavity ratios of about 1:1 in the state of the art are naturally suboptimal for achieving a low weight. It would be better if the cavity were significantly larger in relation to the wall thickness, as this would save a lot of weight without significantly reducing the strength.

According to the invention, a shell can therefore be provided which is made of physically or chemically foamed plastic and is provided with gas channels which are integrally manufactured with the shell.

Due to the foamed structure of the material (the largest foam bubbles are usually in the middle of a cross-section, while the edge areas of the cross-section in a range of about 0.3-0.4 mm from the outside are almost not foamed at all), excess material can be much more easily “peeled off” by the gas. This makes it possible in particular to make the ratio of cavity diameter and wall thickness as large as possible in gas channels. For example, it is conceivable to achieve a cavity diameter of 3 mm with a wall thickness of 1 mm, i.e. a ratio of 3:1, or even more. This allows the material used and thus the weight to be massively reduced.

The shell according to the invention is preferably executed integrally with a circumferential hollow profile along its edge, whereby the outer shape of the profile is simultaneously designed in an overlapping manner, so that two different shell halves, for example two suitcase shells, interlock and close off and stiffen the suitcase as a frame. A further preferred variant is to provide two C-shaped hollow profiles instead of a circumferential hollow profile. This allows the plastic to be driven specifically in one direction in the injection mould, thereby achieving complete filling of the mould. The hollow profile is preferably placed along the edge on the inside of the shell, which allows the outside to be made smooth and without a bead. On the other hand, a circumferential undercut is created, which blocks the demoulding of the component. This undercut could be solved with sliding tools that are located in the mould. If the transition from the shell wall to the hollow profile is executed smoothly and fluidly, the component can also be stretched during demoulding, when the plastic is still relatively warm and soft, and thus be forced out of the mould.

The shell is preferably stiffened at several points by gas channels, these channels being chosen to support the flow of the plastic in the mould. For example, it is conceivable to choose the injection point at one end of the suitcase and to provide some straight gas channels parallel to the flow direction in the suitcase surface.

In a preferred method, during the injection moulding process, the component is initially only partially filled, and then the gas pressure is introduced into the channels. The gas pressure then forces the plastic into thin areas of the shell. This allows the wall thickness to be less than 2 mm, depending on the flow properties of the plastic, even less than 1.5 mm, without further measures.

The timing of the gas introduction can vary, and in particular it is important to consider how long the gas pressure is maintained. Thus, it is also possible to completely fill the mould with injection moulding and only then start the gas introduction. This overfills the mould, and overflow cavities must be provided into which the excess plastic mass can escape. It is also conceivable to start the gas introduction already at a partial filling and then maintain it for a long time, i.e., until the complete filling and beyond.

If the injection points are specifically chosen in relation to the intended gas channels, their number can be kept relatively low. In a first step, the plastic is pressed into the mould at one or more injection points. The diameters of the later hollow gas channels are much higher than the thickness of the rest of the shell. In the first step, the plastic therefore flows particularly easily into the gas channels. The gas injection can start later, i.e., when the injection mould has already been (partially) filled with plastic. The gas pressure in the channels pushes the plastic further into the mould and also fills all thin areas and forms the cavity in the gas channels.

Ideally, a stiffening would be designed as a hollow profile shape, with the ratio of hollow diameter to wall thickness being as large as possible. Stiffenings of this kind have an excellent ratio of weight to strength in all directions, and are not visible from the outside, which significantly improves their appearance and feel compared to traditional ribs. Psychologically and technically, stability is conveyed by the large outer diameters, while these shapes are very light due to the gas inside.

If the gas channels are strategically arranged and used as an additional flow aid, this can further facilitate the filling of the mould. Together with the better flow properties of the foamed plastic, even large wall thicknesses of less than 1.5 mm become possible. This further reduces the weight of the suitcase.

B)

To achieve the longest possible flow paths in relation to wall thickness and thus produce the lightest possible shell, it is also advisable to specifically change the viscosity of the plastic. For example, there are special plastics that are kept particularly flowable due to their chemical or physical additives and fillers. For example, so-called chemical flow aids can be added, or fillers made of glass, ceramics, carbon, and the like can be added. Especially in round form, these fillers can lead to an improvement in the flow properties. This is known in the market. The disadvantage of this method is that the choice of possible plastics is greatly limited and the mechanical and optical properties of the plastics may be adversely affected.

Another method to reduce the weight of the shell is the use of foams, or the additional foaming of conventional plastics. In thermoplastic foam injection moulding (TSG for short), the thermoplastic material is made to foam in the cavity by adding a physical or chemical blowing agent to the plastic before or during the injection process. Fillers can also help transport the foaming gas or the chemical agent. For example, it is known in the market that certain physical foaming methods work better if the plastic is mixed with glass fibers, as the foam particles stick better to these glass fibers.

A new method of physical foaming according to the invention is to introduce the foam into the plastic using special hollow fillers or additives. Here, hollow or gas-filled bodies made of plastic, ceramics, glass, and other solid substances can be mixed with the plastic. These hollow solid bodies are made to burst in the cavity of the injection mould by pressure and/or heat and/or chemical reaction. This causes the gas to be released directly in the injection mould and to foam. If the hollow bodies are round and small, the flow behaviour of the plastic can also change positively during the injection process. When foaming, the cavity is generally first partially filled to give the plastic the necessary space for its expansion, which takes place during foaming.

Alternatively to foaming the plastic by bursting the hollow fillers, it can also be provided that the hollow fillers do not burst during the injection moulding process and the gas remains trapped inside the hollow fillers. By adding hollow fillers that remain intact during the injection moulding process, a structure of the plastic can be achieved that is similar or identical in its properties during injection moulding to that of a foamed plastic. All statements in this document about foamed plastic therefore also apply analogously to plastics to which hollow filler bodies are added.

The hollow filler bodies preferably have a diameter of less than 100 μm. For non-spherical filler bodies, the diameter corresponds to an equivalent diameter.

An important but less well-known side effect of the process, when applied to thin-walled shells, is an extension of the flow paths of the foamed plastic compared to the compact plastic. The foamed plastic flows much more easily into the mould, thereby reducing the required injection pressure and the cycle time, among other things.

Another advantage of using foamed plastic is that larger differences in wall thickness become possible than is the case with compact plastics. This allows high-stress areas of the shell to be reinforced specifically, without making the rest of the shell heavier as a result.

A further advantage of using foamed plastic is that ribs on one side reflect less, or not at all, on the opposite side. Thus, a rib:wall thickness ratio of 1:1 or even more becomes possible, without sink marks becoming visible. This makes it possible to rib a suitcase shell on the inside, for example along the frame or surfaces, without these ribs impairing the outer appearance of the suitcase due to sink marks.

According to the invention, a shell can therefore be provided which has ribs on the inside of the frame and/or the surface of the shell, and the suitcase shell is made of plastic, and the plastic was foamed using chemical or physical foaming methods.

However, a major disadvantage of the process is the very poor surface quality. Although there are now special individual types of plastic that offer an acceptable surface even with TSG methods, this would greatly limit the choice of materials and high-gloss surfaces are also hardly possible with this. This is because the foam often leads to streaking on the surface, which is very unattractive. It is also the case with many plastics that chemical blowing agents discolour the plastic to a yellowish hue, making it harder to produce the plastic object in white or pastel colours, for example.

DE102010015056A1 describes a method for producing a coated plastic component. The component is first manufactured by injection moulding through physical or chemical foaming of plastics. However, this foaming leads to poor surface quality. In a second operation, therefore, this bad surface is coated. This coating is done with softer material such as polyurethane, by introducing it into the mould or by later spraying. A disadvantage of this method is that the coating adds additional weight, additional steps and thus additional costs. The coating is also not particularly scratch-resistant and only adheres to a limited extent to the plastic component. Since the component is thus made of two different materials, recycling of the component is at least greatly impeded or made impossible.

US2014065335A1 describes a suitcase that combines two layers of different materials. A thin outer layer is combined with a thick foam layer. It is clear that such a material composite requires multiple steps to manufacture, and in any case, the interior is restricted by the full thickness of the foam layer.

DE2827199A1 also describes a similar structure as a combination of foam and thin outer layer.

Also, CN204260019U describes a structure made from foam as a middle layer between two thinner outer layers of deep-drawn hard plastic.

All these methods of combining a lightweight foam layer with a high-quality surface of a compact outer layer are naturally very laborious and expensive.

A new method to produce high-quality foamed surfaces, even high-gloss ones if needed, is the “Variotherm” process. In this process, the tool is alternately cooled and heated. Due to the hot tool surface during the injection process, the plastic melts optimally on the tool surface. Even foamed plastics thus obtain a high-quality surface without post-processing or combination with other materials. Another method to hide the streaks typical for TSG on the surface is to provide the component with a strong graining on the surface.

Another side effect of the hot tool surface is that it also supports the flow of the plastic in the mold, as cold tool surfaces would contribute to the plastic solidifying and thus becoming more viscous.

According to the invention, a shell or suitcase shell can therefore be provided, which is produced by the TSG process, and whose surface quality is made great through the Variotherm process or strong graining, and whose wall thickness can be less than comparable shells.

In conventional foaming methods, particularly with thin wall thicknesses, less than 10% of the weight can be saved by the foam.

In injection molding, however, the core pull mechanism, or negative injection compression is common knowledge. Both variants have in common that the volume of the cavity (shortly after filling the cavity with foamed plastic) is expanded. For example, devices can be provided in the injection mold that locally or along the entire shell expand the wall thickness of the shell from 1 mm to 2 mm. The foam in the plastic can expand much more strongly and swells up to fill the entire, now enlarged, cavity. In this example, a component with a wall thickness of (locally) 2 mm is thus produced, but with the weight of a component of 1 mm wall thickness, thus a weight saving of 50%.

If this method is combined with the Variotherm process, a closed, visually appealing and also high-gloss surface can be produced.

A preferred variant of the invention is therefore that the volume of the cavity is expanded shortly after the same original cavity is filled, and the foam in the plastic swells up and fills the now larger cavity.

C)

In suitcase construction, the shell is further processed after machining: For example, the shells are reinforced at their edge by frames made of aluminum or plastic, by riveting or welding these frames.

Alternatively, a zipper is sewn onto the shell. Handles are attached, wheel housings and wheels are attached, the pull-out bar is fixed in some complex steps, a handle recess is attached, and so on.

So, a large number of other components, which in turn of course had to be manufactured separately, are usually manually attached to the shell. This drives the cost of a suitcase significantly higher. For the most cost-effective production, it is therefore advantageous to integrate as many functions as possible into the shell. Another major disadvantage of suitcases composed of numerous components and thus materials is that they can hardly be recycled anymore. Assuming the individual materials could theoretically be recycled (which is by no means guaranteed), an elaborate disassembly and sorting of the components would still be necessary. Often, the components are not connected with screws, but by rivets, welding, sewing, gluing and the like. This makes disassembly of the components even more difficult or even impossible.

Furthermore, many components consist of several materials, for example because hard plastics are overmolded with soft plastics, foams are combined with hard plastics, or because metal parts are combined with plastic parts, and the like. This also makes recycling in practice impossible. It is therefore not surprising that most suitcases end up in the landfill after their use.

Previous inventions foresee the integration of hinges or handles, but do not mention concrete solutions or approaches for the integration of more complex attachments such as wheels, pull-out bars, and the like. Many materials are combined, some of them are irreversibly connected.

US20040231941A1, for example, describes a frame made of injection-molded plastic with integrated handles, whereby the frames were covered with a fabric. The fabric is laboriously clamped at the end of the frame. The suitcase does not have wheels.

WO2016053387A1, on the other hand, describes an injection-molded, solid base plate of a suitcase made of otherwise flexible material. The base plate has integrated mounting points for the attachment of wheels, which were injection-molded as part of the base plate. However, the rest of the suitcase remains unmentioned and would certainly have to be manufactured separately and connected to the base plate.

DE000008009984U1, in contrast, describes a suitcase that has specifically integrated mounting points for wheel axles. This should make it possible to attach the wheels to the suitcase without additional components. For this purpose, a construction from a thin (deep-drawn) outer shell and an internally applied foam layer is proposed. The invention only provides for coaxially mounted wheels, i.e., no swiveling wheels. The foam layer can be applied in different thicknesses or densities at different locations. However, the integration of hinges or handles is not provided.

DE000069530362T2 describes a suitcase with devices for accommodating the wheels. However, the suitcase does not have a telescopic rod. The suitcase shells have overlapping, stiffening frame constructions to a certain degree at their edges (see FIG. 8). From the outside, the suitcase thus receives distinctive circumferential lips or beads. In the open state, the overlapping area stiffened with ribs is openly visible. The suitcase is also equipped with various handles and wheels that serve to pull the suitcase, but it is not described to what extent the wheels or the wheel mountings are integrated.

U.S. Pat. No. 6,367,603 integrates a hinge device and handles into the shell. However, the hinge requires a metal pin to function. The shells provide openings into which either standing feet or wheels can optionally be inserted—the wheels or wheel mountings are therefore not manufactured integrally with the shell, but are inserted as an extra component into the openings and fastened there. The pull-out handle has a specially designed locking mechanism, but the linkage of the pull-out handle is attached in the conventional way inside the suitcase (“male and female tubes in accordance with PCT/US99/03368”).

U.S. Pat. No. 5,564,538A1 provides for a guide tube 18, which is attached to a central partition 12 of the suitcase and which was therefore not made integrally with the partition. The shells are independent of this partition. It is unclear how the guide tube is made in concrete terms, but it is certainly attached to the partition. The guide tube is therefore not manufactured integrally with the shells or with the partition.

WO2017137995 A1 shows a suitcase made by injection molding, where a “flexible closure”, apparently a zipper, is connected to the shell during the injection molding process. The document also mentions longer channels 119b on the shell for accommodating a telescopic rod. These channels are supposed to be made by “retractable inserts”, but the expert is aware that inserts must have demolding slopes in order to be separated from the plastic after the injection molding process. If there were no demolding slopes, removal of the insert would be impossible, as the force required due to the friction of the plastic on the insert would be too high. If we assume a demolding slope of only 1° (and one degree is already very little in practice), then a tube that starts with a diameter of 30 mm would taper down to a diameter of only 12.54 mm within 50 cm length of a suitcase shell. It is obvious that a tube made in this way could not possibly be suitable for guiding or holding a telescopic rod, or rather, the telescopic rod would not be able to have a larger diameter than 12 mm and would then no longer be held or precisely guided in the wide area of the channels (at 30 mm diameter).

The only theoretical possibility for manufacturing these channels in practice would be inserts that can be reduced in radial direction like a folding core. This would be a particularly complex variant of manufacturing and is not considered at any point in the document. Given the dimensions given in suitcase construction, such a folding core construction would be extremely complex, as many movable parts would have to be mounted in a diameter of only 30 mm. Also, the process path of the inserts would be extremely long, as the entire 50 cm would have to be demolded.

The suitcase also has drill holes 114 for receiving wheel axles 116, but it is not mentioned exactly how the wheel axles are attached to the drill holes.

Even though it is known from the literature to integrate individual attachments into the shell or base plate of the suitcase, no shell has been developed that integrates all attachments. Particularly the telescopic pull-out rods (or the lower stages of the telescopic pull-out rods) or other guide devices have never been practically integrated into the shell.

Known telescopic handle devices (telescopic pull-out rods) for suitcases consist of a handle and usually several inter-slidable (telescopic) tubes or rods. In the following text, only tubes or rods will be mentioned, regardless of whether the profile of the rod or tube is circular or has a special other shape. Different constructions and profiles of tubes are known from practice, in particular there are versions with two adjacent telescopic tube arrangements and such versions with only one single telescopic tube arrangement. For the invention it is irrelevant which of the known versions is chosen and it is therefore irrelevant whether we are talking about a single movable tube or several movable tubes.

In conventional constructions of, for example, three telescopic stages, the tube with the largest diameter is usually firmly attached to the suitcase. Usually, the largest (aluminum) tubes in the suitcase interior are held by a separately produced plastic part, which plastic part in turn is firmly connected to the suitcase shells, for example with screws, rivets and the like. This largest tube of the telescopic pull-out handle construction, which is firmly connected to the suitcase shell, is subsequently referred to as the “largest tube” or “pull-out rod cavity”.

The task of the invention is therefore to develop a shell that can be produced extremely inexpensively in injection molding and has all attachments such as wheels or wheel fixations, carrying handles, telescopic system or the largest tube of the telescopic system, hinges, buckles, frames, handle recesses and the like integrated, or at least provides devices for the easy attachment of these elements. These devices can be special devices or projections on the shell, holes for the attachment of elements and the like. It is important that the attachment of elements can be done as simply and uncomplicatedly as possible, i.e., without complex tools and as quickly as possible.

In addition, the suitcase should be designed so that it can be recycled as simply and as quickly as possible. All (structural) components should therefore be designed so that disassembly can be carried out quickly and without problems, and so that the components are then available in a sorted manner.

The existing inventions are each limited to individual elements that are to be integrated and therefore offer only a limited advantage. The extent of the cost savings remains relatively small. There is also no suitcase that is specifically designed for later recycling.

This problem is solved by a piece of luggage according to claim 1. Preferred embodiments are specified in the dependent claims.

The integration of hinges, frames and handles has already been discussed in the existing literature. However, the integrative production of wheel mounting points, as well as the largest tubes of the telescopic pull-out rod as part of the shell, has not at all been solved, which is why it will be discussed in more detail below.

The main problem with the integration of long, tubular shapes (as needed for the largest tube of the telescopic pull-out rod) in a shell produced in injection molding is that these tubes must run transverse to the demolding direction of the shell. The tube thus represents a long undercut. Theoretically, this could be solved with a very long slider or a very large insert in the injection mold, but for this, you would need demolding slopes, whereby the tube can no longer be formed parallel and thus loses its guiding function.

The main advantage of integrating the largest tube into the suitcase shell lies in a reduction in the costs and effort required for the production of the suitcase.

In addition, the weight of the suitcase could be reduced through the integration, as the largest tube could be made of plastic as part of the shell (“pull-out rod cavity”) and no longer made of aluminium. If the largest tube, as is common with most suitcases, is to be placed touching the suitcase shell wall, the suitcase wall can simultaneously form a segment of the tube, further reducing the weight. Furthermore, the rigidity of the shell can be increased at the same time, as the hollow cross-section of the pull-out rod also serves as a tube-like stiffening of the shell (pull-out rod cavity).

Traditional telescopic tubes are usually made of aluminium. The largest tube of the construction is usually firmly connected to the suitcase and is not moved relative to the suitcase. Instead, movable tubes are moved inside each other and in the larger tube. However, it is not aluminium on aluminium that is shifted, but strictly speaking, each individual tube usually has a roughly 4 cm long plastic buffer on its upper end, which allows the next smaller tube to slide in it. In the extended state of the telescopic construction, it is essentially the plastic buffer that holds the next smaller tube at its lower end. The smaller the tolerance of the plastic buffer to the next smaller tube, the less the construction wobbles, and the higher is the perceived quality of the suitcase. Also, a large part of the force during use of the suitcase rests on the zone of the plastic buffer.

Thus, if a telescopic tube with a plastic buffer function is to be integrated into the lightest possible suitcase shell, a variety of requirements must be taken into account: The area of the plastic buffer must be made stronger (thicker) than the rest of the area, and it must be able to be produced with very low tolerance. The rest of the telescopic rod, on the other hand, can be made relatively thin, as it has to absorb comparatively low forces. The plastic buffer should lie as close as possible to the next smaller tube in order to keep the tolerance low, while the rest of the area should offer some distance to the tube, otherwise too large frictional forces would be exerted on the tube, making the movement of the pull-out handle construction too laborious.

The objective of the invention is solved through the combination of a short slider with an integrated gas injection, at the end of which a projectile is placed, which, driven by gas or a fluid, pushes the molten plastic mass ahead during the injection molding process, leaving a cavity behind.

The projectile injection technique (PIT) is known from DE102009048837A1. In this case, a tubular hollow element, such as a fluid line in the automotive sector, is formed by means of a projectile. The projectile is driven by gas or water and pushes itself through the plastic, leaving behind a relatively precisely defined cavity with a thin wall all around.

In PIT, the projectile itself is usually made of the same plastic as the actual workpiece. When penetrating the workpiece, the projectile melts a little, so the tolerance of the diameter of the cavity cannot be precisely and exactly reproduced.

Therefore, it is advantageous if the area of the plastic buffer is not formed by a projectile, but by a traditional slider in the injection molding tool. This slider can accurately maintain the optimal tolerance for the next smaller tube for the short required length of about 2-8 cm.

The slider is preferably attached at the upper end of the shell, i.e., where the next smaller tube should protrude from the suitcase during use. The grip recess, which accommodates the grip, is also preferably integratively manufactured with the suitcase shell.

However, the remaining length of the largest telescopic rod cannot be created by a slider. Therefore, a projectile is attached to the slider, which is driven by gas or fluid, pushes itself through the plastic and thus forms the required cavity. The gas or fluid is preferably introduced through the slider itself for this purpose, or alternatively introduced near the slider through another opening.

The projectile is preferably larger in diameter than the slider, because this can create the required distance to the next smaller tube, while the slider creates the close tolerance to the smaller tube.

Since the largest tube or the telescopic rod cavity is integrally manufactured with the suitcase shell, and the shell will have a much lower thickness over wide areas than the diameter of the tube, the use of a projectile offers another significant advantage: The projectile displaces the plastic mass in the tube with great force and thus serves as an additional flow aid for the plastic. This allows a thinner wall thickness and thus a lighter suitcase to be created in the rest of the shell than would be possible without a projectile.

As with the introduction of gas for the gas channels, the timing for igniting the projectile is variable and should be chosen depending on the design of the shell and the injection molding machine. Thus, ignition can in principle already be provided for a partial fill, or alternatively only for a complete fill. If excess mass is to be expelled from (even only from individual areas of) the injection mold, overflow cavities must be provided in the injection mold.

Alternatively to the profile, the required cavity could also be created by gas injection or fluid injection. However, these two methods usually result in larger remaining wall thicknesses relative to the cavity diameter and generally a less precisely controlled cavity, and are therefore inferior to this application of the projectile technique.

To make the best possible use of the flow aid function, it is advisable in any case to design the transition area between the hollow profile and the suitcase shell to be fluid, i.e., with a larger radius.

The above-mentioned problem solutions are advantageous, but relatively complex to implement. A simpler possibility for a solution satisfactory to the customer is that the short area of the telescopic rod buffer is made by a slider, and the rest of the tube is either represented by an additional cover inside the suitcase (see FIG. 8b), or that alternatively the shell jumps back after the telescopic rod buffer and the movable tube becomes visible from the outside (see FIG. 8a). The first variant is aesthetically the most appealing, but the second variant is lighter and cheaper in contrast, as a cover is no longer necessary.

Accordingly, a suitcase shell can be provided according to the invention, which integratively provides the telescopic rod buffer together with the shell. Since the telescopic rod buffer area will usually be made much thicker than the rest of the shell in order to be able to absorb the corresponding forces, there is a significant difference in the cooling speed and the deformation of this area compared to the rest of the shell. These disadvantages can be overcome by previously mentioned physical or chemical foaming, especially in combination with fillers (possibly combined with variotherm temperature control of the mold).

Nowadays, suitcases are almost exclusively manufactured with 4 wheels (one wheel or double wheel at each suitcase corner). These 4 wheels are each connected with a horizontal metal axis, the “wheel axis” (which allows the wheel to rotate and connects the wheels to a wheel holder) and a vertical metal axis, the “wheel mounting axis” (which allows the direction change of the wheels and connects the wheel holder to a “wheel housing” (which ensures the connection between the suitcase shell and the wheel mounting axis and is itself usually fixed to the shell using rivets and screws).

This construction is thus heavy, consists of many components, and is prone to failure. When breaks occur in the suitcase, it is often the connection between the wheel housing and shell that breaks, or the shell or the wheel housing itself, as the shell is severely weakened at this point by the necessary openings for screws and rivets.

To reduce the manufacturing costs of a suitcase, decrease its weight, and simultaneously increase its strength, it is appropriate to revise the complex constructions from the prior art. This problem is solved by directly integrating the wheel mounting axis into the shell already during the injection molding process of the shell.

A concrete possibility to achieve this is that the mounting area for the wheel mounting axles is created by a designated thread in the suitcase shell, which is integrally connected to the suitcase shell. A threaded hole is created in the shell by a slider with a thread. The threaded hole should be designed so that the wall of the threaded hole is strong enough and this wall is integrally manufactured with the shell of the suitcase. After the manufacturing of the shell, the wheel mounting axis is screwed into this thread, thus being replaceably attached.

Formularbeginn

Another possibility is that the wheel mounting axles are made of the same plastic as the suitcase shell and are manufactured integrally with the suitcase shell. In this case, the wheel mounting axis itself is part of the suitcase shell and protrudes from it. The wheel holder is then attached to the plastic wheel mounting axis with a screw.

A third possibility is that the wheel mounting axles are formed as insert parts, which are overmolded during the injection molding process of the shell. For this, the wheel mounting axles (preferably made of metal or plastic) are initially placed in the injection mold and subsequently overmolded during the injection molding process of the shell.

All these variants significantly reduce the number of parts and therefore also the weight and costs of the suitcase. In any case, the vertical wheel mounting axis is ultimately directly connected to the shell, so the wheel housing itself, as well as the connection between the shell and wheel housing and the connection between the wheel mounting axis and wheel housing are no longer necessary.

Because the wheel mounting axis interacts directly with the shell, it is possible to distribute the forces acting on the wheel mounting axis more broadly to the shell. Since the shell no longer needs to accommodate openings for screws or rivets to attach the wheel housing, it is significantly less prone to breakage.

Formularende

The invention will be further explained in the following using preferred, non-restrictive examples with reference to the drawings. The figures show in detail:

FIGS. 1a and 1b show the same (suitcase) shell 5 from different perspective angles. Visible is a circumferential gas channel along the open edge of the shell 1, two exemplary gas channels 2 along the largely flat areas of the shell, and gas channels 3 at the rounded areas of the shell. The gas channels 3 open at their lower end into the areas of the wheel mounts 4 and at their upper end into the corners of the suitcase and are therefore strategically placed to reinforce highly stressed areas of the suitcase shell in a targeted manner. All gas channels are placed at a suitable distance from each other and can be used to drive the plastic into the thin-walled areas of the shell during the injection molding process. In FIG. 1b, integrated wheel mounting axles 6 are also recognizable, which in this example were made from the same plastic and during the same injection molding process as the shell.

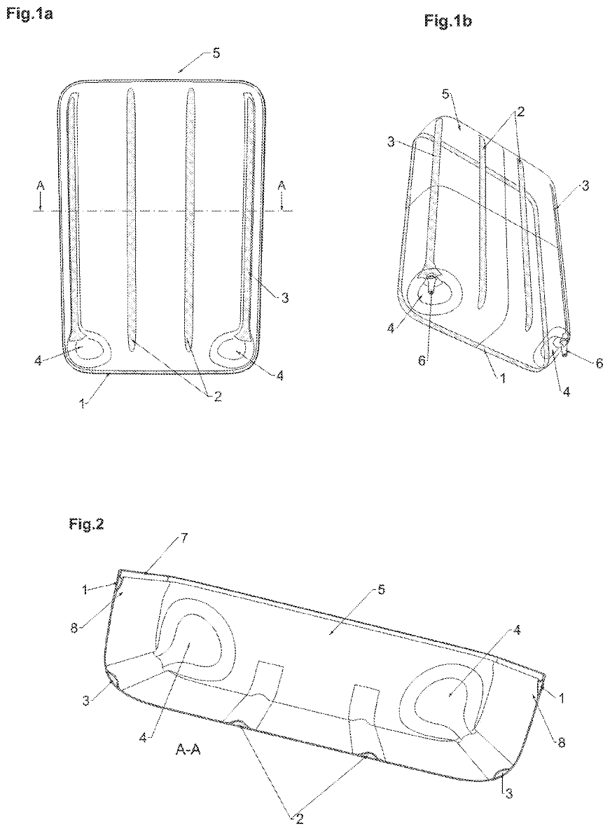

FIG. 2 shows section A of FIG. 1a in perspective and additionally clarifies that the gas channels can be arranged in the inner area of the shell 5, whereby the externally visible area of the shell remains visually smooth, free to design, and undisturbed. It can be seen that the gas channel 1 along the open shell edge leads into an overlapping area 7 of the shell, which area serves for the connection with a possible second shell. The gas channel 1 can either be inside or outside the shell. If it is arranged inside the shell, as shown here as an example, an undercut 8 is created. It is therefore advantageous to gently shape the form of the gas channel 1 into the shell as shown, which makes it possible to forcibly remove the shell from the injection mold without slide tools.

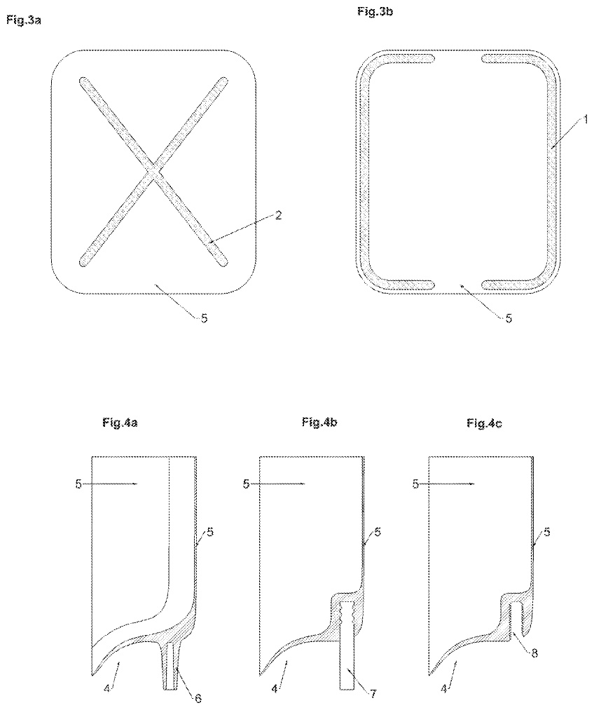

FIG. 3a and FIG. 3b show further, non-restrictive exemplary embodiments of gas channels as they might be attached to containers or shells, where the number of possible variants and shapes are limited more by technical conditions than by imagination. FIG. 3a shows gas channels 2 in the form of an X on the largely flat areas of the shell, which stiffen them very well. Here, the gas channels stiffen the surface like beads. FIG. 3b shows two C-shaped gas channels 1, which could be particularly advantageously attached to the open edges of the shell.

The final choice of gas channel shape is closely linked to the function and load of the shell, as well as the injection point. Cross shapes as in FIG. 3a are, for example, more suitable for an injection point near the center of the cross. First, you would partially fill the shell through the injection point, with the thicker gas channels significantly accelerating the flow of the plastic in the mold. In a second step, the gas pressure pushes the plastic into all corners of the injection mold. In FIG. 3b, on the other hand, it might be more advantageous to choose the injection point at the bottom of the shell. The C-shaped gas channels are then suitable for pushing the plastic upwards in the mold and at the same time stiffening the open edges of the shell. Of course, a combination of different shapes and injection points is also conceivable, for example, C-shaped gas channels on the open edges of the shell and X-shaped gas channels on the flat areas, and so on.

FIGS. 4a, 4b, and 4c show examples of variants of the integration of wheel mounting axles into the shell 5, each as a section through the shell in the zone of the wheel mounting axles in the area of the wheel mount 4.

FIG. 4a shows wheel mounting axles 6 integrated in one piece with the shell 5, whereby the wheel mounting axles are injection molded as part of the shell. In the area of the connection of the wheel mounting axle to the shell, increased use of material is advantageous, possibly combined with stress-optimized shaping of the transitions between the shell and the wheel mounting axle. In this way, acting forces can be optimally distributed and derived.

FIG. 4b shows the variant of an overmolded insert 7 as a wheel mounting axle. For this purpose, the wheel mounting axle 7 is placed in the injection mold before the injection molding process and then overmolded with plastic in a single operation. The wheel mounting axle 7 can be provided with grooves and the like to ensure optimal hold of the wheel mounting axle in the shell 5.

FIG. 4c shows the variant of an integrated thread 8 in the shell 5, whereby the wheel mounting axle is subsequently attached in the shell by means of a thread and is thus replaceable.

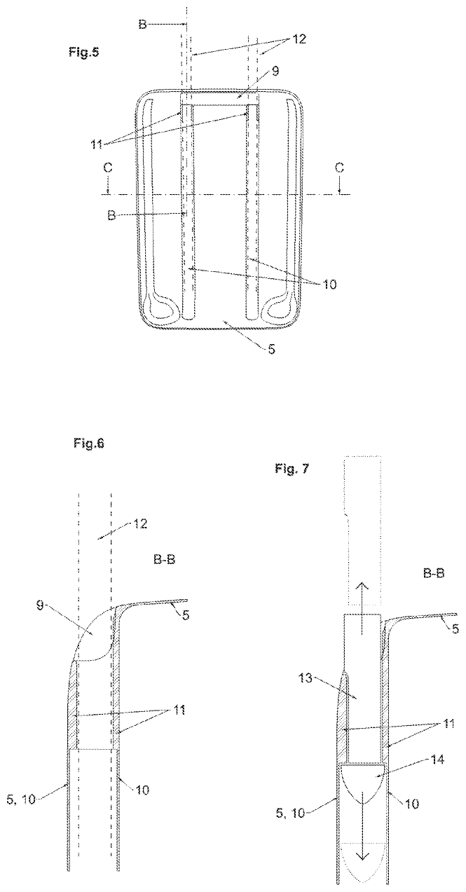

FIG. 5 and FIG. 6, as well as FIGS. 7, 8a and 8b, with FIGS. 6, 7, 8a and 8b depicting the upper area of section B-B of FIG. 5, show a suitcase shell 5 with integratively produced largest tube 10 or telescopic rod cavity 10. The next smaller, movable tube 12 of the telescopic rod construction is shown in dashed lines. The movable tube 12 is guided in close tolerance by integratively produced telescopic rod buffers 11, while the integratively produced telescopic rod cavity 10 of the telescopic rod construction provides further tolerance for the movable tube 12. The handle recess 9 is also produced integrally with the shell 5 and serves to store the extendable handle (not shown).

FIG. 6 shows that the shell 5 is also simultaneously part of the largest tube 10 of the telescopic rod construction.

The length of the largest tube or telescopic rod cavity 10 can be arbitrarily determined and depends on the number of tubes that can be telescoped into each other, the height to be reached by the telescopic rod handle in the use position, as well as the dimensions of the suitcase.

The next smaller movable tube 12 can be made in such a way that fixation and holding of the tube 12 in 11 or 10 is made possible by movable pins, automatic locks, triggers and the like (not shown). Such pins and triggers are well known in the state of the art in various versions. FIG. 7 schematically shows the device for producing the integratively produced elements 10, 11 with the shell 5. For this purpose, a slide 13 is used to form the telescopic rod buffer 11, at the end of which a projectile 14 is attached. First, the injection mold is (partially) filled with plastic, then the projectile is fired and thus forms the largest tube or the telescopic rod cavity 10. In the last step, the slide 13 is withdrawn from the mold.

The end of the largest tube or telescopic rod cavity 10 can be shaped as desired, with the injection mold either being able to provide devices for removing the projectile 14, thereby saving weight in the suitcase, or alternatively the projectile can also remain in the suitcase and after its path through the shell, it merges with the plastic at the tube end or end of the telescopic rod cavity 10. The telescopic rod cavity 10 can also bend along with the radius of the suitcase shell at the bottom end of the suitcase, thereby additionally stiffening the suitcase shell in this area.

FIGS. 8a and 8b each show variants that are less complex in manufacture and dispense with the formation of the largest tube or telescopic rod cavity. Instead, only the telescopic rod buffer 11 and the handle recess 9 are integratively produced with the shell 5. This obviates the relatively complex use of the projectile 14 from FIG. 7. The disadvantage is that the projectile can no longer be used as a flow aid for the plastic, making it more difficult to produce the shell 5 as thin-walled as possible. Also disadvantageous is that the no longer existing integratively produced largest tube 10 can no longer serve to stiffen the shell accordingly.

The embodiment of FIG. 8a provides that the shell 5 largely recedes parallel to the profile of the movable tube 12 in the area of the tube 12. In the stowage position, the movable tube 12 is thus visible from the outside. This massively influences the design of the suitcase from the outside, but on the other hand, a particularly low weight of the suitcase is achieved. The shell 5 delimits the tube 12 from the interior of the suitcase.

In contrast, the embodiment of FIG. 8b provides that the shell 5 remains on the outside and an additional cover 15 is provided, which delimits the movable tube 12 from the clothing in the interior of the suitcase.

FIG. 9 shows the section C-C in perspective from FIG. 5. The telescopic rod cavity 10 is integratively produced with the shell 5 and transitioned with a large radius 16, which allows the plastic to flow into the thinner area of the shell 5. The profile of the telescopic rod cavity is oval in this example, but could also be shaped differently. The profile of the telescopic rod cavity is formed internally by the projectile. It is also exemplarily visible that the telescopic rod cavity in area 17, where the wall of the suitcase shell transitions via a large radius into the bottom surface of the suitcase shell, flows together with the suitcase shell towards the inside. After that, the telescopic rod cavity ends. This formation of the telescopic rod cavity additionally increases the stiffness between the wall and the bottom of the suitcase shell.

In this embodiment, the telescopic rod cavity is also supplemented with gas channels 1 and 3, with the circumferential gas channel 1 stiffening the open edge of the shell and transitioning into an overlap area 7. Alternatively, the gas channel 1 could also not be fully circumferential, but in the form of two Cs, as shown in FIG. 3b. The gas channels 3 are parallel to the telescopic rod cavity 10 and transition fluidly, that is, stress-optimized, into the wheel areas 4, thus stiffening these high-stress areas.

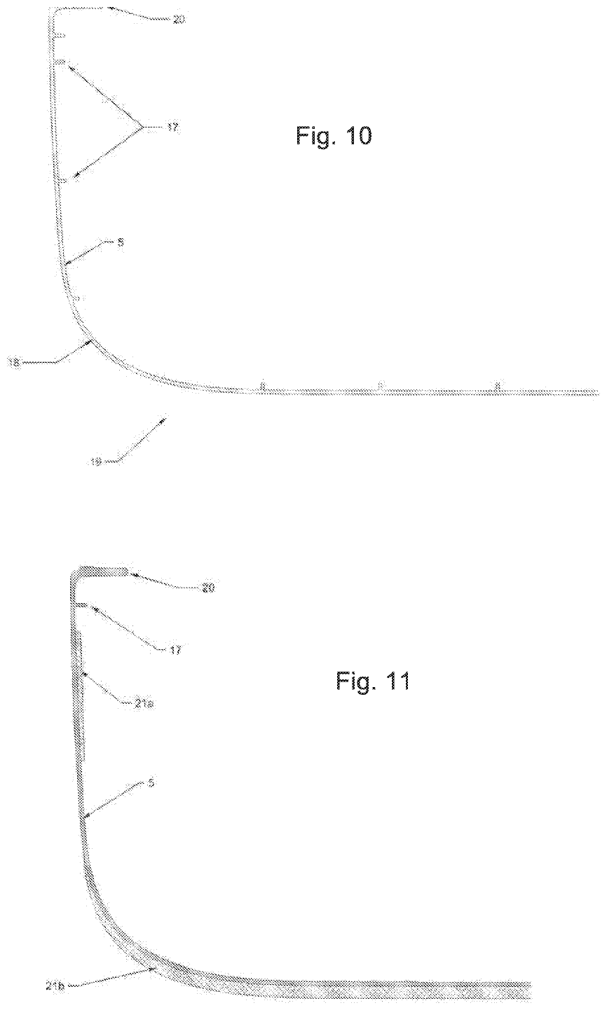

FIG. 10 shows a cross-section through the sidewall and a part of the flat area of the shell 5. This shell 5 was made using fillers and/or flow aids 18, which allow the production of a very thin wall thickness of less than 1.5 mm. The shell 5 has an inwardly standing circumferential frame 20, as well as numerous internal ribs 17. Due to the fillers 18, the ribs 17 are not visible on the outside 19 of the shell 5, or the ribbings 17 do not show through due to sinks. The outside 19 thus remains smooth and aesthetically pleasing. The circumferential frame 20 and the ribs 17 could in principle also be attached to the outside, which would make the injection mold less complex. However, suitcases, especially hand luggage suitcases, are limited in their maximum dimensions by the specifications of airlines, and frames protruding to the outside would thus reduce the usable volume of the suitcase.

FIG. 11 shows a cross-section through the sidewall and a part of the flat area of the shell 5. In this implementation example, it is shown that the volume of the shell 5 filled with foamed plastic is expanded after the injection process around areas 21a and 21b. This can be achieved by negative injection compression or core pulls. This significantly increases the stiffness in these regions without increasing the mass of plastic in the shell. For example, 21a is expanded towards the inside of the basic wall thickness of the shell, while 21b is expanded towards the outside.

The foamed plastic can be produced by chemical or physical foaming or also by using hollow fillers filled with gas, which burst during the injection molding process due to chemical or physical conditions and release their gas. In addition, the shell in this example has a circumferential frame 20 and ribbings 17.

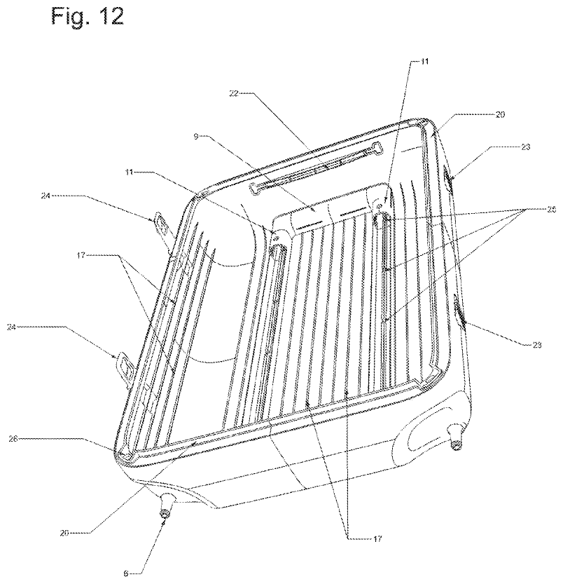

FIG. 12 shows a perspective view of a shell 5, with mainly the inside of the shell visible. Numerous ribbings 17 can be seen on the sidewalls and on the surface of the shell. The telescopic rod buffer 11 (here drawn exemplarily according to FIG. 8b) is integrally produced with the shell. In this example a production using internal and external sliders in the injection mold would be conceivable. The telescopic rod buffer 11 seamlessly transitions into a grip recess 9, which is intended to accommodate the telescopic handle.

The ribs are reinforced in the area where the telescopic rod will be moved and also serve to guide the telescopic rod. To allow the rods to lock in a specific height at different positions, locking points 25 are provided. The pin of the telescopic rod mechanism can lock into these locking points, thereby fixing the rod at different heights. The uppermost locking point is located within the telescopic rod buffer 11. In this example, the locking points 25 are created by interruptions of the ribs, but could also be manufactured in many other forms. In any case, the locking points are integrally manufactured with the shell.

The shell also features fastening elements 23 for attachments, which are developed for the tool-less attachment of hinges. In addition, there is a reinforced area with holes 22, which serves for the attachment of a handle. The buckles 24 are also integrally manufactured with the shell in this example. In this case, the buckles would function like a snap closure and lock into the corresponding shell (not shown).

The wheel axles 6 are also integrally made with the shell. The shell also has a circumferential, in its profile L-shaped frame 20, with openings 26, which are intended for the attachment of a divider-fabric. The L-shape of the frame creates an overlap to the opposite shell, which keeps the two shells in position relative to each other. If a rubber buffer is also attached to the frame, the shell can theoretically also be sealed watertight.

1: An injection molded container or shell (5), especially suitcase shell made of plastic, wherein A) the shell is made of foamed plastic and has gas channels (1,2,3) and/or B) the shell (5) is made by physically or chemically foamed plastic and/or from a plastic mixed with hollow fillers and/or C) the shell is integrally made with wheel axle mounts (6) and/or pull rod buffer (11) and/or pull rod cavities (10).

2: The container or shell according to claim 1, wherein the fillers or additives are essentially round and have a diameter of less than 100 μm.

3: The container or shell (5) according to claim 1, wherein the shell has ribs (17) inside, which do not appear as sink marks or other marks on the visible side (19) due to fillers or chemical/physical foaming.

4: The container or shell (5) according to claim 1, wherein the wheel axle mounts (6) are formed from the same plastic as the container or shell (5) and are integrally made with the container or the shell (5).

5: The container or shell (5) according to claim 1, wherein a receiving area for the wheel axle mounts is created by a provided thread (8) in the container or shell (5), which is integrally connected to the container or the shell (5).

6: The container or shell (5) according to claim 1, wherein the pull rod buffer (11) is integrally made with the container or the shell (5).

7: The container or shell (5) according to claim 1, wherein the container or shell (5) is integrally made with a frame (20), which stiffens the open edges of the shell and/or wheel axle mounts (6,7,8) and/or at least one pull rod buffer (11) and/or fixing points (25) for a sliding tube, and/or at least one closure element (24) and/or further devices for the attachment of additional components (22,23), in particular hinges, buckles, handle recesses (9), handles 5 and the like.

8: A method for producing the container or the shell (5) according to claim 1 by injection molding, wherein hollow fillers or additives are introduced into the plastic and/or a gas for producing a foam is introduced into the plastic by means of hollow fillers or additives and during the injection molding process, the gas escapes from the fillers or additives and the plastic is foamed by the gas.

9: The method according to claim 8, wherein the fillers or additives are essentially round and have a diameter of less than 100 μm.

10: The method according to claim 8, wherein the plastic is injected into a cavity of an injection mold and a volume of the cavity is increased shortly after filling the cavity and the plastic is foamed in the process and completely fills the enlarged cavity.

11: The method according to claim 8, wherein the temperature of a tool surface of the injection mold is kept high during an injection process and is lowered for demolding of the component.

12: The method according to claim 8, wherein additives and/or fillers increasing the flow rate of the plastic are added to the plastic and the container or shell (5) is made with a wall thickness of less than 1.5 mm.

13: The method according to claim 8, wherein the pull rod cavity (10) is formed during the injection molding process by a projectile (14).

14: The method according to claim 8, wherein the pull rod cavity (10) is formed by gas injection or fluid injection.

15: The method according to claim 8, wherein the pull rod buffer (11) is produced by a slider (13), and/or wherein the slider (13) holds retaining devices for a projectile (14) and preferably the gas supply for the launch of the projectile is guided through the slider (13).

16: The method according to claim 8, wherein the wheel axle mounts (7) are placed as insert part in the injection mold, which is overmolded during the injection molding process of the shell.

17: A method for producing the shell or the container, in particular suitcase shell (5) according to claim 1, by injection molding, comprising the steps:
providing an injection molding machine and plastic granules and an injection mold, which is equipped for the production of gas injection channels. Melting of the plastic granules;
introducing the molten plastic into the injection mold, the gas injection being started even during the injection process of the plastic into the injection mold, that is, after only partial filling of the injection mold, and/or after complete filling of the injection mold and thus the occurring pressure of the gas injection supports the flow of the plastic in the mold and the complete filling of the injection mold and/or excess plastic mass is pressed into overflow cavities;
wherein the plastic is foamed by physical or chemical blowing agents and the injection mold is heated to an elevated temperature at the injection time, which is suitable for keeping the plastic soft and flowing in the injection mold and the injection mold is cooled after complete filling of the mold for solidification of the plastic.

18: A method for producing the shell (5) or the container, in particular a suitcase shell, with an integrated extendable rod cavity (10) and/or integrated extendable rod buffer (11) according to claim 1 by injection molding, including the steps:
providing an injection molding machine and plastic granules and an injection mold, which is equipped for a projectile;
providing a slider with suitable dimensions for forming an extendable rod buffer (11), which slider is equipped with an integrated device for igniting a projectile (14) attached to it;
melting the plastic granules.
introducing the molten plastic into the injection mold after a partial filling of the injection mold and/or after a complete filling of the injection mold, whereby the projectile is driven by gas pressure or fluid pressure and the occurring pressure of the projectile or the displacement of the plastic by the projectile supports the flow of the plastic in the mold and the complete filling of the injection mold and/or excess mass is diverted into overflow cavities;
forming a hollow channel (10) by the projectile in the shell, which channel is suitable for the attachment and/or guidance of extendable rod devices;
retracting the slider, leaving behind a cross-section with suitable dimensions for forming an extendable rod buffer (11).
